(19) United States
(12) Patent Application Publication
(10) Pub. No.: US 2020/0210798 A1
(43) Pub. Date: Jul. 2, 2020

(54) HIGH TEMPERATURE RADIO FREQUENCY IDENTIFICATION (RFID) TAG

(71) Applicant: Technologies ROI LLC, Mauldin, SC (US)

(72) Inventors: Patrick F. King, Mauldin, SC (US); William Adams, Laurens, SC (US)

(21) Appl. No.: 16/705,726

(22) Filed: Dec. 6, 2019

Related U.S. Application Data
(60) Provisional application No. 62/785,855, filed on Dec. 28, 2018.

(51) Int. Cl. G06K 19/077; G06K 19/07; G06K 19/08

(52) U.S. Cl. CPC G06K 19/0773; G06K 19/083; G06K 19/0723

(57) ABSTRACT

High temperature radio frequency identification (RFID) tags are formed from nesting insulative ceramic structures with a woven cladding provided around an RFID tag. Additional interstitial woven cladding may be positioned between the ceramic structures. The layered approach provides sufficient insulation that allows sustained operation at temperatures above 500-600 degrees centigrade (500-600° C.) while being sufficiently transparent to radio frequency (RF) signals to allow interrogation and response for track and trace purposes even at such elevated temperatures.

### PRIORITY CLAIM

The present application claims priority to U.S. Provisional Patent Application Ser. No. 62/785,855 filed on Dec. 28, 2018 and entitled “HIGH TEMPERATURE RADIO FREQUENCY IDENTIFICATION (RFID) TAG,” the contents of which is incorporated herein by reference in its entirety.

### BACKGROUND

### I. Field of the Disclosure

The technology of the disclosure relates generally to radio frequency identification (RFID) tags that cohesively operate in elevated temperature environments.

### II. Background

Radio frequency identification (RFID) tag systems include an RFID tag that transmits data for reception by an RFID reader (also referred to as an interrogator). In a typical RFID system, individual objects (e.g., store merchandise) are equipped with a relatively small tag that contains a transponder. The transponder has a memory chip that is given a unique electronic product code. The RFID reader emits a signal activating the transponder within the tag through the use of a communication protocol. Accordingly, the RFID reader is capable of reading and writing data to the tag. Additionally, the RFID tag reader processes the data according to the RFID tag system application allowing for great versatility in track and trace applications. Currently, there are passive and active RFID tags. The passive-type RFID tag does not contain an internal power source, but is powered by radio frequency signals received from the RFID reader. Alternatively, the active-type RFID tag contains an internal power source that enables the active-type RFID tag to possess greater transmission ranges and memory capacity. The use of a passive versus an active tag is dependent upon the particular application.

RFID tag systems have found use in a variety of applications. While early RFID tag system applications included animal identification, beer keg tracking, automobile key-and-lock, and anti-theft systems, other industries realized that RFID tag systems would have possible applications.

Industries that employ heat curing of any form such as paint, metal, molded materials, food, etc. may wish to specifically track and trace from origin to finish the intended product or semi-finished product. Such industries also include automotive, aerospace, metal foundries, plastics molding, bakeries, meat smoking and cooking facilities, hospital sterilizations, and many more. The needs for RFID within these industries is real, and current autoidentification marking tools such as bar code and etching marking have limits due to the need for optical data collecting and inability to embed the mark below the surface.

Where there is heat present in the operating environment, conventional RFID tags may not be sufficiently thermally stable to operate normally. RFID thermal stability rests principally with the characteristics of the core integrated circuit (IC). For example, Impinj, a company that makes many RFID tags, notes three temperatures that are key, including the upper threshold for warrantee life at 260 degrees centigrade (also referred to as Celsius) (260° C.). In essence, high heat may melt the solder within the RFID tag, decoupling the antenna from the IC of the tag. Even higher heat may adversely affect the operation of the semiconductor material of the IC of the tag.

A survey of the industry for RFID tags reveals some companies reporting capabilities and offerings up to 250° C. as they do not want to or cannot realistically offer products that perform normally even when exposed to lengthy exposure at or above 260° C.

In early 2002, Technologies ROI (TROI) began to develop tags that operated above 260° C. Around 2010 TROI launched a series of first-of-kind 300° C. RFID tags followed by a series of 400° C. tags in 2014.

The industry at large accepts that tags above 400° C. are not currently available despite a current industry demand for an RFID tag that can withstand 500° C. or 600° C. Finding materials that can operate at these temperatures is challenging.

### SUMMARY OF THE DISCLOSURE

Aspects disclosed in the detailed description include high temperature radio frequency identification (RFID) tags. In an exemplary aspect, nesting insulative ceramic structures with a woven cladding are provided around an RFID tag. Additional interstitial woven cladding may be positioned between the ceramic structures. The layered approach provides sufficient insulation that allows sustained operation at temperatures above 500-600 degrees centigrade (500-600° C.) while being sufficiently transparent to radio frequency (RF) signals to allow interrogation and response for track-and-trace purposes even at such elevated temperatures.

In this regard in one aspect, a method of using an RFID tag is disclosed. The method includes conducting sustained operations with the RFID tag while the RFID tag is exposed to temperatures above 450° C.

In another aspect, an apparatus is disclosed. The apparatus includes an RFID tag, a first woven fabric cladding surrounding the RFID tag, and a first ceramic housing encapsulating the first woven fabric cladding. The apparatus also includes a second woven fabric cladding surrounding the first ceramic housing and a second ceramic housing encapsulating the second woven fabric cladding.

### BRIEF DESCRIPTION OF THE FIGURES

FIG. 1 is a block diagram of an exemplary radio frequency identification (RFID) tag;

FIG. 2 is a perspective view of the RFID tag of FIG. 1 encapsulated in a first woven insulative cladding;

FIG. 3 is a perspective view of the RFID tag of FIG. 2 being placed in a first ceramic shell;

FIGS. 4A-4D are views of an RFID tag insulated in a set of nested ceramic shells;

FIG. 5 is a perspective view of a set of nestable ceramic shells disassembled to show an RFID tag in a woven insulative cladding;

FIG. 6 is a flowchart illustrating an exemplary process for manufacturing an insulated RFID tag according to the present disclosure; and

FIG. 7 is a flowchart illustrating usage of the insulated RFID tag according to the present disclosure.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include high temperature radio frequency identification (RFID) tags. In an exemplary aspect, nesting insulative ceramic structures with a woven cladding are provided around an RFID tag. Additional interstitial woven cladding may be positioned between the ceramic structures. The layered approach provides sufficient insulation that allows sustained operation at temperatures above 500-600 degrees centigrade (500-600° C.) while being sufficiently transparent to radio frequency (RF) signals to allow interrogation and response for track-and-trace purposes even at such elevated temperatures.

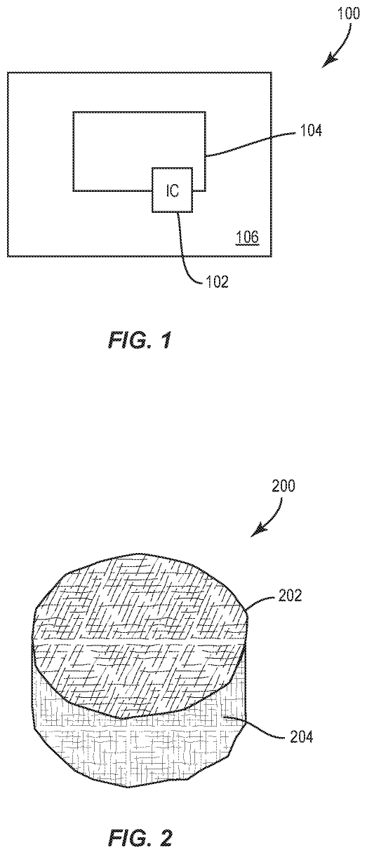

In this regard, FIG. 1 illustrates a simplified diagram of an RFID tag 100 (sometimes referred to as an RFID device). The RFID tag 100 includes a chip or integrated circuit (IC) 102 and an antenna 104 placed on a substrate 106. The antenna 104 may have any of a variety of well-known configurations, such as that of a loop antenna, dipole antenna, or slot antenna. The antenna 104 is operatively (directly or indirectly) coupled to contacts on the IC 102 to send and receive signals in communication with another device, such as a reader or a detector. The communication may passive, with the RFID tag 100 drawing power from an electric or magnetic field or a propagating electromagnetic wave (or any combination thereof) produced by a reader or detector, and using the power to alter or modulate the electrical field. References herein to use of an electric field should be understood as alternatively involving a magnetic field, a propagating electromagnetic wave, or any combination of electric fields, magnetic fields, and propagating electromagnetic waves. Alternatively, the communication may be active communication, with signals actually broadcast from the RFID tag 100.

The IC 102 may be any of a variety of IC devices used for controlling communication of the RFID tag 100. Functions of the IC 102 are carried out by circuitry of the chip, using a variety of well-known electronic structures. The IC 102 may be directly coupled to the antenna 104 (e.g., by soldering) or may, alternatively, be coupled to the antenna 104 using an intervening structure such as an interposer or strap. Such an interposer or strap may have conductive leads that facilitate electrical connection between the IC 102 and the antenna 104. Such electrical connection may be an electrical connection direct contact, characterized by a low electrical resistance, or alternatively a reactive electrical connection, where the contact is via an electric field, magnetic field, or a combination.

The RFID tag 100 may be embodied as a label or tag and may be attached or mechanically coupled to an object. The RFID tag 100 may include solder or other layers including adhesive layers as is well known. In an exemplary aspect the RFID tag 100 is a Smart-Mark label, sold by William Frick & Company of Libertyville, Ill., USA.

Exemplary aspects of the present disclosure place an RFID device such as RFID tag 100 in a series of insulative layers beginning with woven cladding to form an intermediate assembly. The intermediate assembly is then placed in a series of nested ceramic shells to provide a final assembly.

In this regard, FIG. 2 shows an intermediate assembly 200, where the RFID tag 100 is inside an outermost layer 202 of woven silica cloth—also referred to as woven fabric cladding 204. As illustrated, the woven fabric cladding 204 is generally cylindrical although other shapes may be used. The woven fabric cladding 204 forms an air barrier around the RFID tag 100. In an exemplary aspect, the woven silica cloth is selected from one of the following materials manufactured by THERMEEZ: 395 and 397—Woven Tape; 395S and 397S—Adhesive Backed tape; 395C and 397C—Woven Cloth; and 395T and 397T—Woven Sleeving.

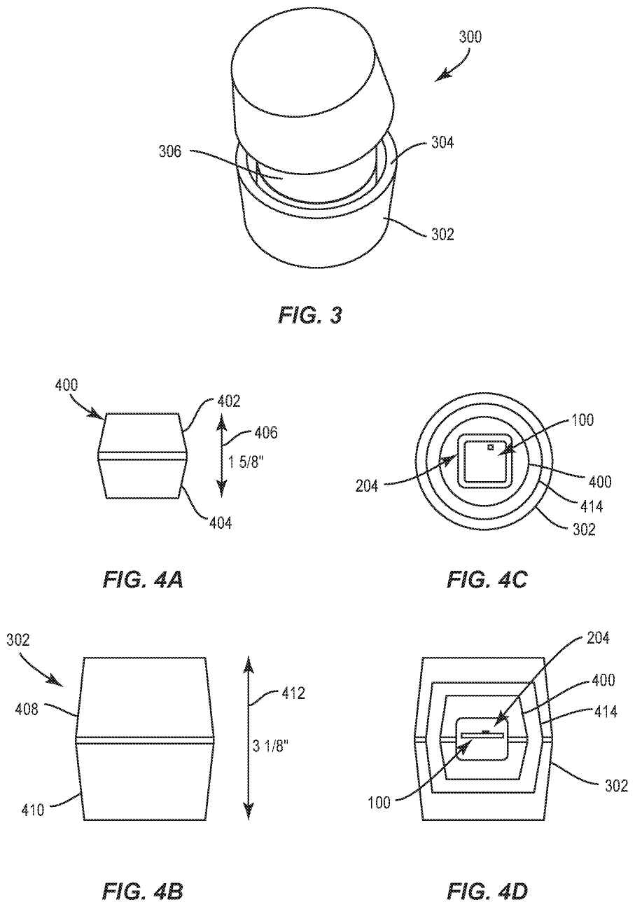

The intermediate assembly 200 is then placed in at least one, and, in an exemplary aspect, up to three nested ceramic shells (although more may be used). In this regard, FIG. 3 shows an insulated final assembly 300 partially opened. That is, an exterior ceramic shell 302 is shown partially open along a seam 304 to show an interior ceramic shell 306. The intermediate assembly 200 is inside the interior ceramic shell 306. As illustrated, there is no woven fabric cladding between the exterior ceramic shell 302 and the interior ceramic shell 306, but the present disclosure contemplates aspects where there is such a woven fabric cladding between the ceramic shells.

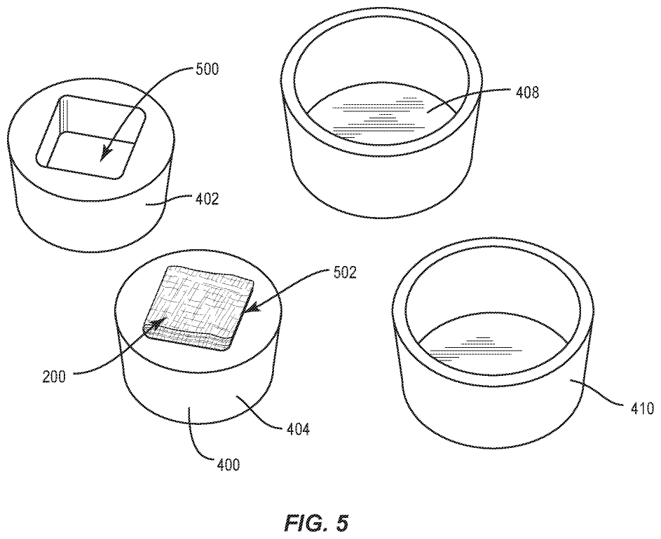

FIGS. 4A and 4B show external views of ceramic shells such as may be used by exemplary aspects of the present disclosure. In particular, FIG. 4A illustrates an interior ceramic shell 400 having a general barrel shape with flattened top 402 and bottom 404. A ceramic weld secures the top 402 to the bottom 404. As noted, a vertical dimension 406 may be one and five-eighths inches. Similarly, FIG. 4B illustrates an exterior ceramic shell 302 having a general barrel shape with flattened top 408 and bottom 410. A ceramic weld secures the top 408 to the bottom 410. As noted, a vertical dimension 412 may be three and one-eighth inches. As better seen in FIGS. 4C and 4D, which are cross-sectional views of FIG. 4B, there may be multiple nested ceramic shells. Specifically, an interior ceramic shell 400 is nested inside an intermediate ceramic shell 414. The intermediate ceramic shell 414 is nested inside exterior ceramic shell 302. While only three nested ceramic shells are shown, it should be appreciated that more could be used. Likewise, while only the shells 302, 400, and 414 are shown, it should be appreciated that additional woven fabric cladding may be positioned between the shells 302, 400, and 414, As best seen in FIG. 4C, the RFID tag 100 is inside the outermost layer 202 of woven fabric cladding 204.

As an additional view, FIG. 5 illustrates two ceramic shells, with the intermediate assembly 200 positioned in the interior ceramic shell 400. The interior ceramic shell 400 may include a cavity or recess 500 in the top 402 and a complementary cavity or recess 502 in the bottom 404 sized to hold the intermediate assembly 200. As shown, the recesses 500, 502 are generally rectilinear but may be shaped to hold the cylindrical shape of the intermediate assembly 200. In the event that the intermediate assembly 200 is more wafer shaped, the recesses 500, 502 may be shaped to hold such different wafer shape. When assembled, the interior ceramic shell 400 is placed inside the bottom 410 and the top 408 cemented thereto.

Exemplary materials used for the apparatus disclosed herein may be: Cotronics Ceramic Resin, for example.

The cement to bind the tops of the shells to the bottoms may be a Cement by Rescor 750 (Shock Resistant) part #750-1 also available 740 (insulating foam), 760 (Ultra Temp), 770 (Corrosion Resistance), 780 (General Purpose), and RTC-60 (High Purity).

As intimated above, while the shape of the ceramic shells 302, 400, 414 are generally barrel or tubular, the shape is not central to the present disclosure. Square, rectangular, trapezoidal, pyramid-like, and other geometric shapes can be employed. In addition, the surfaces of the ceramics can have features such as fins or patterns intended to diffuse or deflect heat.

In addition, the number of layers and combinations for materials vary depending on application requirements for size and heat exposure.

Initial testing has shown the RFID tag 100 to operate for over an hour at 415° C. and over an hour at 540° C. That is, the RFID tag 100 is capable of sustained operations, where sustained operations comprise interrogation of the RFID tag 100 and receipt of coherent responses therefrom.

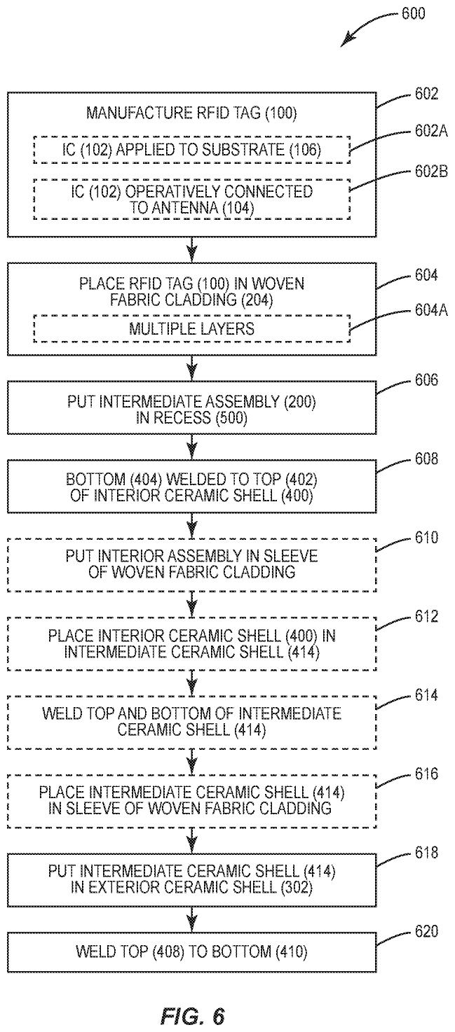

FIG. 6 is a flowchart describing the manufacturing process 600 of the final assembly 300. In this regard, the process 600 begins by manufacturing the RFID tag 100 (block 602). Specifically, an IC 102 is applied to a substrate 106 (block 602A) and operatively connected to the antenna 104 (block 602B) such as through a soldering process or the like. Note that the RFID tag 100 may be purchased as a pre-manufactured product if needed or desired. With continued reference to FIG. 6, the process 600 continues by placing the RFID tag 100 in a woven fabric cladding 204 (block 604). If desired, multiple layers of woven fabric cladding may be used (block 604A) to form intermediate assembly 200 having outermost layer 202.

With continued reference to FIG. 6, the intermediate assembly 200 is placed in recess 500 of the interior ceramic shell 400 (block 606). The bottom 404 of the interior ceramic shell 400 is cemented or welded to the top 402 of the interior ceramic shell 400 (block 608). Optionally, the interior ceramic shell 400 may be placed inside an additional sleeve of woven fabric cladding (block 610).

With continued reference to FIG. 6, optionally, the interior ceramic shell 400 is then placed in an intermediate ceramic shell 414 (block 612). The top and bottom of the intermediate ceramic shell 414 are welded or cemented together (block 614) and optionally placed in another sleeve of woven fabric cladding (block 616). The intermediate ceramic shell 414 is then placed in an exterior ceramic shell 302 (block 618). The top 408 and bottom 410 of the exterior ceramic shell 302 are welded or cemented (block 620) to form a final assembly.

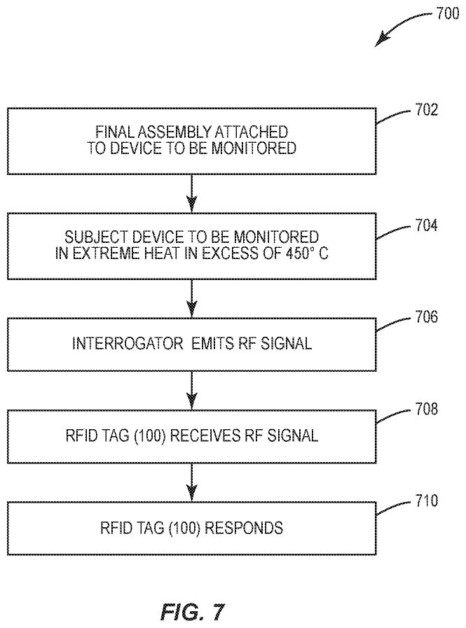

A process 700 for using a RFID tag 100 is illustrated in FIG. 7. In particular, the final assembly is attached to a device to be monitored (block 702). This attachment may be through welding a clasp around the final assembly to the device to be monitored, bolting the final assembly to the device to be monitored, or the like. The device to be monitored is subjected to extreme heat in excess of 450° C. (block 704). An interrogator or reader emits an RF signal (block 706) directed at the final assembly. The RFID tag 100 within the final assembly receives the RF signal (block 708) and responds (block 710) such that the RFID tag 100 conducts sustained operations while exposed to temperatures above 450, 500, 550, or 600 degrees centigrade.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method of using a radio frequency identification (RFID) tag, comprising:
conducting sustained operations with the RFID tag while the RFID tag is exposed to temperatures above 450 degrees centigrade (450° C.).

2. The method of claim 1, wherein the temperature is above 500° C.

3. The method of claim 1, wherein the temperature is above 550° C.

4. The method of claim 1, wherein the temperature is above 600° C.

5. The method of claim 1, wherein conducting the sustained operations comprises interrogating the RFID tag and receiving coherent responses therefrom for more than ten minutes at the temperatures above 450° C.

6. The method of claim 1, wherein conducting the sustained operations comprises interrogating the RFID tag and receiving coherent responses therefrom for more than thirty minutes at the temperatures above 450° C.

7. The method of claim 1, wherein conducting the sustained operations comprises interrogating the RFID tag and receiving coherent responses therefrom for more than fifty minutes at the temperatures above 450° C.

8. An apparatus comprising:
a radio frequency identification (RFID) tag;
a first woven fabric cladding surrounding the RFID tag;
a first ceramic housing encapsulating the first woven fabric cladding;
a second woven fabric cladding surrounding the first ceramic housing; and
a second ceramic housing encapsulating the second woven fabric cladding.

9. The apparatus of claim 8, wherein the first woven fabric cladding comprises a woven silica cloth.

10. The apparatus of claim 8, wherein the first woven fabric cladding surrounding the RFID tag comprises an air barrier for the RFID tag.

11. The apparatus of claim 8, wherein the first woven fabric cladding surrounding the RFID tag comprises a generally cylindrical shape.

12. The apparatus of claim 8, wherein the first ceramic housing comprises a Cotronics ceramic resin.
